(19) United States
(12) Patent Application Publication
(10) Pub. No.: US 2006/0277535 A1
(43) Pub. Date: Dec. 7, 2006

(54) Downloading software applications

(76) Inventor: Andrea KETZER, Ulm (DE)

Correspondence Address: HARRINGTON & SMITH, LLP, 4 RESEARCH DRIVE, SHELTON, CT, 06484-6212, US

(21) Appl. No.: 10/538,158

(22) PCT Filed: Nov. 26, 2003
(86) PCT No.: PCT/IB03/06379

§ 371 Date: Jun. 19, 2006

(30) Foreign Application Priority Data
Dec. 11, 2002 (GB) 0228972.6

(51) Int. Cl. G06F 9/44

(52) U.S. Cl. 717/168

(57) ABSTRACT

An application descriptor describing an application available for download and including a first data element having a first data portion; a second data element identifying the application; and a plurality of third data elements, each of which has an individual locale identifier portion and a second data portion related to its individual locale identifier portion.

Embodiments of the present invention relate to the downloading of software applications. They particularly relate to downloading applications to mobile telephones.

Mobile phones are currently able to run downloaded external applications as well as preinstalled embedded applications. The external application may be a platform independent application that runs on a resident virtual machine in the phone. Java™ applications are the preferred form of platform independent applications.

Java2 Micro Edition (J2ME) defines a Mobile Information Device Profile (MIDP) for mobile phones and similar handheld devices that have constraints on their user interfaces and system components such as processing power and memory size. MIDP is currently at version 2.0. Software applications that conform to MIDP are called MIDlets and are downloaded as part of a MIDlet suite.

A MIDlet suite has two separate parts. The first, the Java Application Descriptor (JAD), describes the applications in the suite and is identified by a data file name with a “.jad” extension. The second, the Java Application Resource (JAR) contains the actual applications (the MIDlets) and it is identified by a data file name with a “.jar” extension. The JAD allows the suitability of the application to be reviewed, by the user of the downloading device or the device itself, before the full JAR file is downloaded.

The JAD comprises a predetermined set of attributes that allow the downloading device to identify, retrieve, and install the MIDlet(s). The format of the application descriptor (JAD) is a sequence of lines consisting of an attribute name followed by a colon, the value of the attribute, and a carriage return. White space is ignored before and after the attribute and the order of the attributes is arbitrary.

The Java Application Descriptor (JAD) of a MIDlet suite must contain the following set of attributes:
MIDlet-Name:
MIDlet-Version:
MIDlet-Vendor:
MIDlet-Jar-URL:
MIDlet-Jar-Size:

The JAD may also contain an attribute for each of the MIDlets in the MIDlet suite. e.g. MIDlet-1:
MIDlet-2:
. . .
MIDlet-<n>:

The syntax of the value for the attribute MIDlet-<n> is: “string1, string2, string3”. e.g. MIDlet-1: Converter, /icons/App.png, com.nokia.mid.appl.Lifecycle.

The first string of the value of the attribute MIDlet-<n> is the name of the nth MIDlet in the MIDlet suite. In this example it is “Converter”. This is the string the end-user will see in the Application's main menu item of the phone. The second string ‘/icons/App.png’ is the application list icon which the end-user can see in front of the MIDlet name, i.e. in front of the first string ‘Converter’ in the list of Java applications.

The third string ‘/com.nokia.mid.appl.Lifecycle’ is the name of the main class, which starts the application. The Java Virtual Machine needs to know which is the start routine to be executed for the application.

The MIDP specification version 1.0 allows the Java Virtual Machine to discover the language/country setting of the device on which it is resident. The JVM has a standard API called System that has a standard method getProperty( ). This method returns the locale property of the device, which specifies its current language and variant e.g. en-US. The variant generally identifies the country. The MIDP 1.0 standard does not describe detailed how the information obtained by getProperty( ) should be used, it contains only a reference to the ISO-639 for the language code and to the ISO-3166 for the country code.

It would be desirable to make the process of downloading a MIDlet suite dependent upon the language/country of the downloading device.

One option would be to use multiple MIDlet suites. One MIDlet suite, comprising several JAR/JAD files, one for each new language/country required in that MIDlet suite. However, as each JAR contains the same application this is an inefficient use of memory as the same JAR file may be stored many times unnecessarily.

An alternative option would be to have a single JAR file but multiple JAD files, one additional JAD file for each language/country. However, the inventor has realized that this option is sub-optimal, particularly for WAP enabled mobile telephones. This is because the Wireless Applications Protocol is designed to transfer a single JAD file and a single JAR file for each MIDlet suite. Consequently, the implementation of, this option would require a serious and expensive modification of the WAP standard and WAP compliant products.

According to one aspect of the present invention there is provided an application descriptor describing an application available for download and comprising: a first data element having a first data portion; a second data element identifying the application; and characterized by a plurality of third data elements, each of which has an individual locale identifier portion and a second data portion related to its individual locale identifier portion.

Each of the third data elements comprises a new attribute for a particular language/country with a value related to that language/country e.g. text in that language.

According to other aspects of the present invention there is provided an application descriptor as claimed in claim 15 or 16.

According to another aspect of the present invention there is provided a mobile telephone as claimed in claim 24.

For a better understanding of the present invention reference will now be made by way of example only to the accompanying drawings in which:

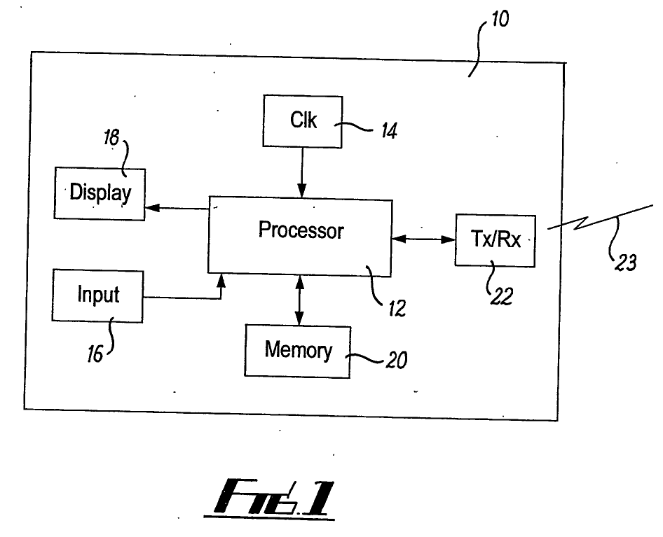

FIG. 1 illustrates a hand-portable device operable in accordance with the invention; and

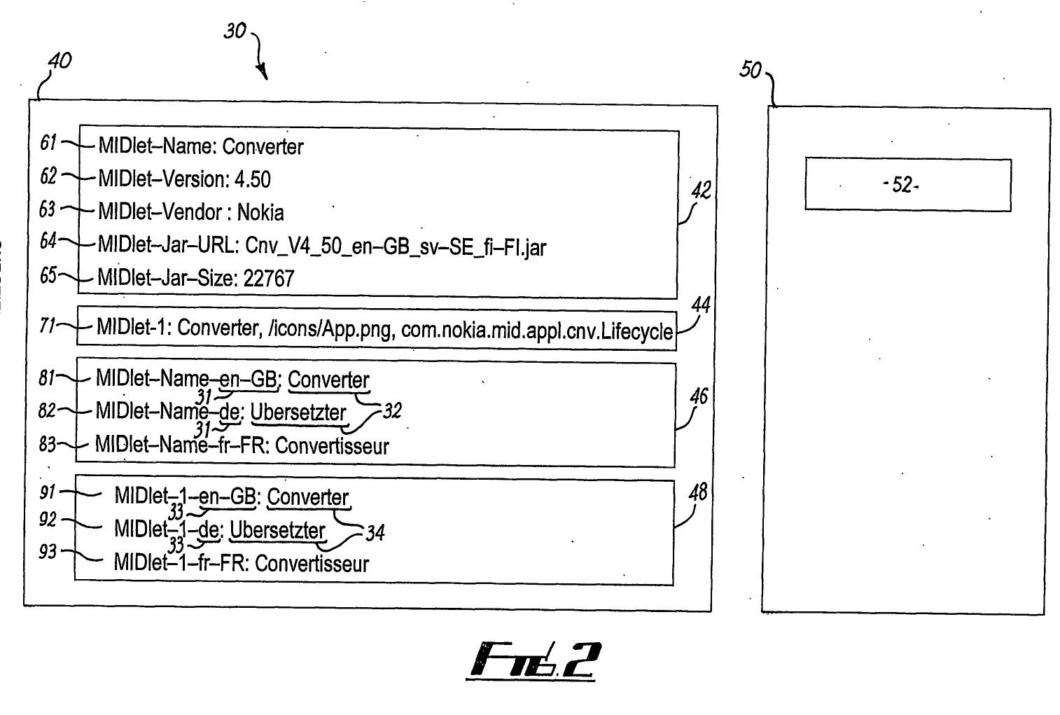

FIG. 2 illustrates a MIDlet suite.

Embodiments of the present invention relate to the modification of the JAD to provide multiple language capability in a MIDlet suite downloaded, for example, to a handheld mobile device, such as a mobile telephone.

FIG. 1 schematically illustrates one-type of suitable hand-portable device 10 for downloading and running an application via a MIDlet suite. The hand-portable device comprises a microprocessor 12, which receives inputs from a clock 14 and an input device 16, which provides an output via a display 18, which is connected to write to and read from a non-volatile memory 20, and which is capable of communicating with a server, storing a MIDlet suite, via a wireless transceiver 22.

The input device 16 may be a one-handed entry keyboard such as the ITU-T phone keyboard, a two-handed entry keyboard such as a QWERTY keyboard, or a touch entry device. The transceiver 22 may be any suitable remote communication means. It may be a cellular radio telephone transceiver for operating in a cellular radio telephone network, it may be a Bluetooth T™ transceiver or it may be an IR transceiver. The hand-portable device 10 may be a WAP enabled cellular mobile telephone that is arranged to download MIDlet suites using the WAP Protocol.

The non-volatile memory 20 stores software which enables the Java Virtual Machine. The Java Virtual Machine is capable of downloading a MIDlet suite via the transceiver 22, storing the MIDlet suite in the memory 20 and running applications (MIDlets) contained in MIDlet suite.

As illustrated in FIG. 2, a MIDlet suite 30 has two separate parts. The first, the Java Application Descriptor (JAD) 40, describes the applications in the suite and is identified by a data file name with a “.jad” extension. The second, the Java Application Resource (JAR) 50 contains the actual application(s) (the MIDlet(s)) and it is identified by a data file name with a “.jar” extension. In the illustrated example, the JAR 50 contains one MIDlet 52. The JAD 40 allows the suitability of the application to be reviewed, by the user of the downloading device or the device itself, before the full JAR 50 is downloaded.

The JAD file will be transferred from a server where it is stored to the downloading device in a data structure 23 dependent upon the transmission protocol used by the transceiver 22. The JAR file will be transferred from a server where it is stored to the downloading device in a data structure dependent upon the transmission protocol used by the transceiver 22.

The JAD comprises a predetermined set of attributes that allow the downloading device to identify, retrieve, and install the MIDlet(s). The format of the application descriptor (JAD) is a sequence of lines consisting of an attribute name followed by a colon, the value of the attribute, and a carriage return. White space is ignored before and after the attribute and the order of the attributes is arbitrary.

The Java Application Descriptor (JAD) of a MIDlet suite must contain the following set of attributes:
MIDlet-Name:
MIDlet-Version:
MIDlet-Vendor:
MIDlet-Jar-URL:
MIDlet-Jar-Size:

The data elements created by the combination of each of the attributes with its associated value are indicated in FIG. 2 by the respective reference numerals 61, 62, 63, 64, 65. The MIDlet-Name gives the name by which the MIDlet suite is identified to the user before download. The JAD may also contain an attribute for each of the MIDlets in the MIDlet suite.

e.g MIDlet-1:

MIDlet-2:

In FIG. 2, there is only one attribute, i.e. one MIDlet in the MIDlet suite. The data element created by the combination of this attribute and its associated value is referenced by numeral 71. The syntax for the value of the attribute MIDlet-<n> is: “string1, string2, string3”. e.g. MIDlet-1: Converter, /icons/App.png, com.nokia.mid.appl.Lifecycle

The first string of the value of the attribute MIDlet-<n> is the name of the n^{th} MIDlet in the MIDlet suite. In this example it is “Converter”. This is the string the end-user will see before downloading the application. The second string ‘/icons/App.png’ is the application list icon which the end-user can see to the left of the MIDlet name, i.e. in front of the first string ‘Converter’. The third string ‘com.nokia.mid.appl.Lifecycle’ is the name of the main class, which starts the application. It identifies the start routine for executing the application.

MIDlet Suite

According to one embodiment of the present invention, a first additional set 46 of attributes is added to the JAR to provide an appropriate translation of the MIDlet suite's name. The data elements created by the combination of each of the attributes with its associated value are indicated in FIG. 2 by the respective reference numerals 81, 82, 83.

The syntax of each of these data elements is MIDlet-Name-<language code>-<COUNTRY CODE>: string or MIDlet-Name-<language code>. The syntax <language code>-<COUNTRY CODE> or <language code> corresponds to that specified by System for the locale property of the device. Each of <language code> and <COUNTRY CODE> is a two-letter code corresponding with ISO-639 and ISO-3166 respectively (as specified in MIDP 1.0).

The <language code>-<COUNTRY CODE> portion of the attribute is a locale identifier and is illustrated in FIG. 2 using reference numeral 31. It identifies a language or a language and a country (the country code is not mandatory). The string, which represents the UK English name of the MIDlet suite, is identified by reference numeral 32 in FIG. 2.

The string for a particular one of the attributes is the name of the MIDlet suite translated into the language indicated by the locale identifier 31 of that attribute. This is the string the end-user will see in the Application's main menu item of the phone.

e.g. The JAD therefore comprises:

MIDlet-Name: Converter
MIDlet-Version: 4.50
MIDlet-Vendor: Nokia
MIDlet-Jar-URL:Cnv_V4_50_en-GB_sv-SE_fi-FI.jar
MIDlet-Jar-Size: 22767
MIDlet-1: Converter, /icons/App.png,
com.nokia.mid.appl.cnv.Lifecycle
MIDlet-Name-en-GB: Converter
MIDlet-Name-de: Übersetzter
MIDlet-Name-fr-FR: Convertisseur

It is possible to have any number of translations of the MIDlet suite name, with a separate attribute for each translation, and not just the translations shown above.

When the device receives a downloaded JAD. If it has not previously called the method getProperty( ) it does so. The locale property of the device (returned <language code>-<COUNTRY CODE>) is returned in reply to the method. The locale property identifies the language the user has selected in his mobile phone. i.e. it identifies the language setting of the mobile phone chosen by the user or the default language setting of the SIM card used by the end-user. The device selects the value of the attribute MIDlet-Name-returned <language code>-<COUNTRY CODE> to replace MIDlet-Name, i.e. the name of the MIDlet suite, if there is one. The user is therefore presented with the name of the MIDlet suite in his or her selected language.

MIDlet(s)

According to another embodiment a second additional set of attributes, one set 48 for each MIDlet of the MIDlet suite, is added to the JAD in addition to (or possibly as an alternative to) the first additional set of attributes.

The first set 46 of attributes is preferably always available, because this contains the MIDlet suite information in the required languages. In the illustrated example, there is one of the second set 48 containing information about the first MIDlet in the MIDlet suite in the required languages. In other examples, there may be other ones of the second set (not shown in FIG. 2 but it would look like the set 48) containing the information about the second MIDlet in the MIDlet suite in the required languages.

The data elements, in the second set 48, created by the combination of each of the attributes with its associated value are indicated in FIG. 2 by the respective reference numerals 91, 92, 93.

The syntax of each of the data elements in a set for the nth MIDlet is MIDlet-n-<language code>-<COUNTRY CODE>: strings

The syntax <language code>-<COUNTRY CODE> corresponds to that specified by System for the locale property of the device. Each of <language code> and <COUNTRY CODE> is a two-letter code corresponding with ISO-639 and ISO-166 respectively.

The <language code>-<COUNTRY CODE> portion of the attribute is a locale identifier and is illustrated in FIG. 2 using reference numeral 33. It identifies a language or a language and country (the country code is not mandatory). The strings are identified by reference numeral 34 in FIG. 2.

The string for a particular one of the attributes is the name of the MIDlet translated into the language indicated by the language (and country code) of that attribute.

e.g. The JAD therefore comprises:

MIDlet-Name: Converter
MIDlet-Version: 4.50
MIDlet-Vendor: Nokia
MIDlet-Jar-URL:Cnv_V4_50_en-GB_sv-SE_fi-FI.jar
MIDlet-Jar-Size: 22767
MIDlet-1: Converter, /icons/App.png,
com.nokia.mid.appl.cnv.Lifecycle
MIDlet-Name-en-GB: Converter
MIDlet-Name-de: Übersetzter
MIDlet-Name-fr-FR: Convertisseur
MIDlet-1-en-GB: Converter
MIDlet-1-de: Übersetzter
MIDlet-1-fr-FR: Convertisseur

It is possible to have any number of translations of the MIDlet name, with a separate attribute for each translation, and not just the translations shown above.

When the device receives a downloaded JAD. If it has not previously called the method getProperty( ) it does so. The locale property of the device (returned<language code>-<COUNTRY CODE>) is returned in reply to the method. The locale property identifies the language of the user. It may, for example, identify the language setting of the mobile phone chosen by the user. The device selects the value of the attribute MIDlet-<n>—returned <language code>-<COUNTRY CODE> to replace string1 of the value of MIDlet-<n>. The user is therefore presented with the name of the nth MIDlet in his or her own language. The syntax of the additional second set of attributes may be expanded to MIDlet-<n>-<country code>-<COUNTRY CODE>: string1, string2, string3 e.g. MIDlet-1-en-GB: Converter, /icons/RedIcon.png/, com/nokia/mid/appl/cnv/StartMIDlet1.class

The first string is the translated name of the nth MIDlet into the language specified by the country code(s) of the attribute. In this case it is the English translation “Converter”. This is the string the end-user will see in the Application's main menu item of the phone.

The second string ‘/icons/RedIcon.png’ is the small icon which the end-user can see in front of the translated MIDlet name, i.e. in front of the first string ‘Converter’

The third string ‘com.nokia.mid.appl.Lifecycle’is the name of the main class, which starts the application. The java Virtual Machine needs to know which start routine to execute for the application.

e.g. The JAD comprises:

| MIDlet-Name: Converter | | |
|---|---|---|
| MIDlet-Version: 4.50 | | |
| MIDlet-Vendor: Nokia | | |
| MIDlet-Jar-URL: Cnv_V4_50_en-GB_sv-SE_fi-FI.jar | | |
| MIDlet-Jar-Size: 22767 | | |
| MIDlet-1: Converter, /icons/App.png, | | |
| com.nokia.mid.appl.cnv.Lifecycle | | |
| MIDlet-Name-en-GB: Converter | | |
| MIDlet-Name-de: Übersetzter | | |
| MIDlet-Name-fr-FR: Convertisseur | | |
| MIDlet-1-en-GB: | Converter, | /icons/RedIcon.png/, |
| com/nokia/mid/appl/cnv/StartMIDlet1.class | | |
| MIDlet-1-fr-FR: | Convertisseur, | /icons/BlueIcon.png/, |

| com/nokia/mid/appl/cnv/StartMIDlet2.class | | |
|---|---|---|
| MIDlet-1-de: | Übersetzter, | /icons/GreenIcon.png/, |

com/nokia/mid/appl/cnv/StartMIDlet3.class

When the device receives a downloaded JAD. If it has not previously called the method getProperty( ) it does so. The locale property of the device (returned<language code>-<COUNTRY CODE>) is returned in reply to the method. The locale property identifies the language of the user. It may, for example, identify the language setting of the mobile phone chosen by the user. The device selects the value of the attribute MIDlet-<n>-returned<language code>-<COUNTRY CODE> to replace the value of MIDlet-<n>. The user is therefore presented with the name of the nth MIDlet in his or her own language, with a country specific icon, and with a different start routine for the application.

For example a Portfolio manager application (MIDlet) could use a US Dollar sign as an icon if the application is used in Americas and a Euro sign if it is used in Europe. The start routine of the MIDlet could say: “Hello America!” when the application is used in America or “Hello Europe!” if it is used in Europe.

The following new attributes have been defined: MIDlet-Name-<language code>-<COUNTRY CODE> and MIDlet-<n>-<language code>-<COUNTRY CODE>. The use of an attribute beginning with the phrase “MIDlet” is protected by the MIDP standard and only standardized attributes can begin with ‘MIDlet’. The foregoing description has been written as if the implementation has been accepted into the standard. It is possible to implement the invention in a proprietary manner by prefacing MIDlet-Name-<language code>-<COUNTRY CODE> and MIDlet-<n>-<language code>-<COUNTRY CODE> with another phrase. For example, one proprietary implementation may use Nokia-MIDlet-Name-<language code>-<COUNTRY CODE> and Nokia-MIDlet-<n>-<language code>-<COUNTRY CODE>.

Although embodiments of the present invention have been described in the preceding paragraphs with reference to various examples, it should be appreciated that modifications to the examples given can be made without departing from the scope of the invention as claimed. For example although the invention has been described in the context of downloading an application to a hand-portable device, it may also be used to download applications to other devices such as a desktop computer.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

Reference numerals are included in the claims as an aid to understanding the relation of the claimed invention to the described embodiments and are not intended to limit the scope of the invention as claimed.

1. An application descriptor describing an application available for download and comprising:
a first data element having a first data portion;
a second data element identifying the application; and
a plurality of third data elements, each of which has an individual locale identifier portion and a second data portion related to its individual locale identifier portion.

2. An application descriptor as claimed in claim 1, wherein an individual locale identifier portion identifies a country and/or a language.

3. An application descriptor as claimed in claim 1, wherein the individual locale identifier portion comprises or identifies at least a language code.

4. An application descriptor as claimed in claim 1, wherein the individual locale identifier portion comprises or identifies a county code.

5. An application descriptor as claimed in claim 1, wherein the individual locale identifier portion comprises a first two-letter code in lower case separated from a second two-letter code in upper case.

6. An application descriptor as claimed in claim 5, wherein the first two-letter code is a language code in accordance with ISO-639 and the second two-letter code is a country code in accordance with ISO-3186.

7. An application descriptor as claimed in claim 1, wherein each of the second data portions of the third data elements are a replacement for the first data portion.

8. An application descriptor as claimed in claim 1, wherein the first data portion defines a name and, for each of the third data elements, the second data portion defines a translation of the name into a language specified by the individual locale identifier portion of the third data element.

9. An application descriptor as claimed in claim 1, wherein the application descriptor is a Java application descriptor, the first data element comprises the value of the MIDlet-Name attribute of the Java Application Descriptor, the second data element comprises the value of the MIDlet-Jar-URL attribute of the Java Application Descriptor and, for each of the third data elements, the second data portion defines a translation of the name defined by the value of the MIDlet-Name attribute into a language specified by the individual locale identifier portion of the third data element.

10. An application descriptor as claimed in claim 6, wherein the application descriptor further comprises:
a fourth data element having a third data portion; and
a plurality of fifth data elements, each of which has an individual locale identifier portion and a third data portion related to its individual identifier portion.

11. An application descriptor as claimed in claim 10, wherein the fourth data element is the value of the attribute for the name of a MIDlet and, for each of the fifth data elements, the third data portion defines a translation of the name of the MIDlet into a language specified by the individual locale identifier portion of the third data element.

12. An application descriptor as claimed in claim 1, wherein the application descriptor is a Java application descriptor, the first data element comprises the value of the attribute for the name of a MIDlet, the second data element comprises the value of the MIDlet-Jar-URL attribute of the Java Application Descriptor and, for each of the third data elements, the second data portion defines a translation of the name of the MIDlet into a language specified by the individual identifier portion of the third data element.

13. An application descriptor as claimed in claim 1 wherein the first data portion defines an icon and the second data portion of the third data element defines a replacement icon.

14. An application descriptor as claimed in claim 1 wherein the first data portion defines a start routine and the second data portion of the third data element defines a replacement start routine.

15. An application descriptor describing an application resource available for download and comprising:
a first attribute having a first value;
a second attribute having a value identifying the application resource;
a plurality of third attributes, each of which has an individual locale identifier portion and has a second value related to its respective individual locale identifier portion.

16. An application descriptor describing an application resource available for download and comprising:
a first attribute having a first value defining a first name;
a second attribute having a value identifying the application resource; and
a plurality of third attributes, each of which has an individual locale identifier portion and has a second value defining a translation of the first name into a language identified by its individual locale identifier portion.

17. A data structure for transmission and reception by a wireless transceiver, comprising an application descriptor as claimed in claim 1.

18. A mobile telephone arranged to receive and process a data structure as claimed in claim 17, comprising a transceiver for receiving the data structure;
means for determining an identifier associated with the phone or the phone user; and
means for selecting the second data portion of a third data element having an individual identifier portion corresponding to the determined identifier associated with the phone or it's user.

19. A mobile telephone as claimed in claim 18 wherein the means for determining an identifier includes means for invoking the getproperty( ) method.

20. A mobile telephone as claimed in claim 18, wherein the identifier comprises at least one country code.

21. A mobile telephone as claimed in claim 18, wherein the identifier is dependent upon the language setting of the mobile telephone

22. A mobile telephone as claimed in claim 18, arranged to receive the data structure using the Wireless Application Protocol.

23. A memory device or data carrier storing an application descriptor as claimed in claim 1.

24. A mobile telephone arranged to process an application descriptor
comprising a first data element having a first data portion, a second data element identifying an application resource for download and a plurality of third data elements, each of which has an individual locale identifier portion and a second data portion related to its individual locale identifier portion, the mobile telephone comprising means for determining a locale identifier associated with the phone or the phone user; and
means for selecting the second data portion of a third data element having an individual locale identifier portion corresponding to the determined locale identifier associated with the phone or it's user.

25. A computer for storing an application descriptor as describing an application available for download and comprising:
a first data element having a first data portion;
a second data element identifying the application; and
a plurality of third data elements, each of which has an individual locale identifier portion and a second data portion related to its individual locale identifier portion, operable for transmitting, receiving or processing a data structure as claimed in claim 17.

26. (canceled)

27. (canceled)
